(19) United States
(12) Patent Application Publication
(10) Pub. No.: US 2006/0170188 A1
(43) Pub. Date: Aug. 3, 2006

(54) Convenient, modular urban and suburban transport vehicle

(76) Inventors: Guy Negre, Carros Cedex (LU); Cyril Negre, Carros Cedex (FR)

Correspondence Address: CONNOLLY BOVE LODGE & HUTZ LLP, SUITE 800, 1990 M STREET NW, WASHINGTON, DC, 20036-3425, US

(21) Appl. No.: 10/524,541

(22) PCT Filed: Aug. 13, 2003
(86) PCT No.: PCT/FR03/02527

§ 371 Date: Aug. 19, 2005

(30) Foreign Application Priority Data
Aug. 13, 2002 (FR) 02/10254

(51) Int. Cl. B60D 5/00

(52) U.S. Cl. 280/403

(57) ABSTRACT

The invention relates to a modular, convenient urban and suburban transport vehicle which is motorised by means of compressed air motor alternators/motorcompressors. The inventive vehicle comprises one or more self-propelled transport modules which are positioned one after the other and which are connected via remote control means to a driving module where the driver is located, such that the number of transport modules can be increased or reduced depending on the passenger capacity requirements. According to the invention, each driving and transport module comprises its own (i) reserves of stored energy and compressed air, (ii) transmission motor assembly and (iii) braking means. Moreover, each transport module comprises a steering system which is remote controlled by the steering system of the driving module which in turn is operated by the driver.

This invention relates to a zero pollution urban transport concept as an alternative to the familiar urban buses or tramways which make up the majority of the surface means currently used for transporting passengers.

Most of our towns are equipped with a system of public transport using urban buses usually comprising vehicles capable of transporting between 50 and 80 people; said buses are between 10 and 12 metres in length and weigh more than 10 tonnes.

The number of passengers using the aforesaid transport system changes during the course of the day between off-peak and peak periods and it is not unusual to see buses running with a limited number of passengers or even with just the driver onboard during off-peak periods.

Moreover, in old towns with narrow lanes, it is necessary to use low capacity buses and to increase the runs to be able to guarantee the service during peak periods, thus, increasing the number of drivers required.

Such vehicles run, for example, on diesel fuel and are highly pollutant.

Such big, heavy, and polluting vehicles are clearly totally unsuitable for this use.

Tramways have the advantage in that they operate pollution free, but they require a very expensive infrastructure and are very large, in addition to the fact that they are limited in their movements by the use of rails which can also be dangerous for two-wheeled traffic.

The author has registered numerous patents relating to motor drive units as well as their installations, more specifically for being fitted to vehicles, using additional compressed air to give a totally clean operation in urban and suburban areas:

| | | |
|---|---|---|
| WO 96/27737 | WO 97/00655 | |
| WO 97/48884 | WO 98/12062 | WO 98/15440 |
| WO 98/32963 | WO 99/37885 | WO 99/37885 |

For implementing these inventions, he has also described in his application for patent WO 99/63206, the contents of which can be referred to, a method and a device for controlling the engine piston movement making it possible to stop the piston at its top dead centre; method also described in his application for patent WO 99/20881, the contents of which can also be referred to, relating to the operating of these engines in single-energy or dual-energy, in dual or triple feed modes

In his application for patent FR 01/13798, the author describes a compressor-alternator unit characterized by the means implemented taken altogether or separately, and more specifically:

in that the diameter of the pistons is of a two-stage design comprising a large diameter crown sliding in a cylinder called engine to guarantee the engine function during the expansion followed by the releasing of the exhaust and of which the aforesaid crown is extended into a smaller diameter second stage piston called compression to guarantee the function of compressing the compressed air stored in the high pressure tank.

in that the second stage pistons are used for the expansion with work function in the ambient thermal energy recuperation system.

in that the means of switching and interaction are installed between the different cylinders making it possible to inactivate the engine function during the compression operation, and/or to inactivate the compressor function during the engine operation, and/or as well, to activate the ambient thermal energy recuperation function during the engine operation.

in that heat exchangers are installed between each compression and/or, thermal energy recuperation expansion cylinder for cooling the compressed air going through them during the compression operation, and/or for heating it during the ambient thermal energy recuperation operation.

in that the engine flywheel comprises the means attached to its periphery to make it possible to produce an electronically-driven electric engine for driving the unit in its compressor function powered by the domestic electric power networks (220V).

in that the electric engine is bi-directional and can be used as a generator or an alternator.

According to a variation of the aforesaid invention, the alternator thus produced makes it possible to start the unit in its engine function by causing it to rotate for at least one engine revolution to make it possible to bring the engine to its compressed air injection position, and/or to take part on an ad hoc basis in increasing the engine torque, or again to produce the electric power during the continuous operation to produce the onboard electric power, or to be used as a decelerator by causing opposing torque during this production of electric power.

Whilst the unit is being used in compression mode using notably the energy supplied by the domestic network, and according to another aspect of the invention, the electric engine is characterized in that its rotation speed is variable, by using a high speed whilst the tank is empty and the torque requested from the compressor drive motor is low to achieve a lower rotation speed that then resembles the shape of the electric engine torque curve.

The electric engine installed on the flywheel can make use of the well-known permanent magnet motor techniques, the aforesaid magnets being fixed to its rotor (which is in fact the engine flywheel) even though the electromagnet coils are mounted almost concentrically, fixed radially or axially, to a suitable integrated casing for the compressor-alternator unit block or even the technologies of variable reluctance motors or other devices known to those skilled in the art, without changing the principle of the invention in any way.

The compressor-alternator unit according to the aforesaid invention is preferably fitted with an ambient thermal energy recuperation system such as described by the author in patent WO 98/32963 where the compressed air contained in the storage tank under extremely high pressure, for example 200 bars, and at ambient temperature, for example 20 degrees, prior to its end use at a lower pressure for example 30 bars, is expanded to a pressure close to that required for its end use, in a variable volume system, for example a piston in a cylinder, producing work which can be recuperated and used by all known mechanical, electric, hydraulic or other means. The result of this expansion with work is that the compressed air expanded to the pressure close to that for its use is cooled to an extremely low temperature, for example minus 100° C. This expanded compressed air at its use pressure, and at a very low temperature is then dispatched to a heat exchanger with ambient air. It will be heated to a temperature close to the ambient temperature, and will thus increase its pressure and/or its volume, by recuperating thermal energy taken from the atmosphere. This operation can be repeated several times in several stages. The ambient thermal energy recuperation system according to the invention is characterized in that the compression cylinders and pistons are used to carry out these successive expansions and in that the heat exchangers used for cooling the air whilst it is used in the compressor are also used for heating the air expanded beforehand and is also characterized in that provision is made for the means to divert so as to successively use the different stages of the recuperation cylinders, the volumes of which are greater and greater, as the pressure reduces in the storage tank so as to allow suitable expansions.

The compressor-alternator unit, according to the aforesaid invention is, again preferably, fitted with a thermal heating system as described by the author in another patent WO99/37885, where he sets out a solution which makes it possible to increase the amount of available and usable energy. This solution is characterized by the fact that prior to its introduction in the combustion and/or expansion chamber, the compressed air coming from the storage tank is channelled, either directly or once it has gone through the ambient thermal energy recuperation system heat exchanger, and prior to its introduction in the expansion chamber, into a thermal heater where, by increasing its temperature, its pressure and/or its volume will again increase prior to its introduction in the combustion and/or expansion chamber, thus significantly increasing the performances that can be achieved by the engine.

The use of a thermal heater has the advantage of being able to use continuous clean combustion which can be catalyzed or freed of pollution by any known means in the aim of obtaining low levels of polluting emissions.

The thermal heater can use a fossil fuel such as petrol, diesel or even GPL GNV gas for energy, thus making it possible to achieve an external combustion dual-energy operation where a burner will cause a rise in temperature.

According to another variation of the invention, the heater advantageously uses the thermo-chemical processes based on absorption and desorption processes, such as those used and described for example in patents EP 0 307297 A1 and EP 0 382586 B1, these processes using the transformation by evaporation of a fluid for example liquid ammonia to a gas reacting with salts like calcium, manganese or any other chloride, the system operates like a thermal battery where in a first phase the evaporation of the store of ammonia contained in an evaporator on the one hand produces cold and on the other a chemical reaction in the reactor containing the salts which gives off heat, when the store of ammonia is exhausted, the system can be refilled in a second phase by a heat input in the reactor which reverses the reaction where the ammonia gas breaks down from the chloride, and returns to a liquid state via condensation.

The application according to the aforesaid invention is characterized in that the thermo-chemical heater thus described uses the heat produced during phase 1 to increase the pressure and/or the volume of the compressed air coming from the high pressure storage tank, prior to its introduction in the master cylinder expansion chamber.

During phase 2, the system is regenerated by the input of the heat given off by the exhaust pipes from the various stages of the compressor during the compressor operation for refilling the main high pressure storage tank.

According to a variation of the aforesaid invention, the compressor-alternator unit is equipped with a burner, or any other, type thermal heater and a thermo-chemical heater as previously cited which can be used at the same time or successively during phase 1 of the thermo-chemical heater where the burner type thermal heater will make it possible to regenerate (phase 2) the thermo-chemical heater when the latter is empty by heating its reactor as the unit operation continues with the use of the burner type heater.

According to another embodiment of the aforesaid invention, the compressor-alternator unit equipped with a thermal heater operates independently, without using the high pressure compressed air contained in the storage tank, by drawing compressed air supplied by one or several compression stages according to the required work pressures; this compressed air is then heated in the heating system where its temperature will increase resulting in the increase of its volume and/or its pressure, then re-injected into the expansion chambers of the master cylinders making it possible for the unit to operate by expanding and producing the power stroke.

According to another variation of the embodiment above, and when the unit is operating independently, the expansion cylinder exhaust air is diverted to the thermal heater either directly, or through one or more stages of compression where its temperature will increase resulting in the increase of its pressure and/or its volume, then re-injected into the expansion chambers of the expansion cylinders making it possible for the unit to operate by producing the power stroke. A pressure relief valve in the exhaust system, prior to the thermal heater, makes it possible to control the aforesaid pressure and release any excess air into the atmosphere.

According to a variation of the embodiment above, part of the compression air can be diverted and used and/or other stages of the compressor are used to refill the main tank whilst the engine is operating independently as described above.

The compressor-alternator unit thus equipped operates in dual-energy mode by using in town for example, the pollution free operation with the compressed air contained in the high pressure storage tank, and on the open roads, again for the independent operating example with its thermal heater powered by a fossil energy, whilst refilling the high pressure storage tank from one or more of its compression stages.

The compressor-alternator unit operates with four sources of energy which can be used jointly or separately during its use, according to the performances sought after or required:

Compressed air energy contained in the high pressure storage tank is the main source and is notably used to give a totally clean operation in urban areas.

Thermo-chemical energy is used to increase the performances and the autonomy of use by pollution free operating.

1. Fossil energy for the burner-type heater which is used for:
increasing performances and autonomy of use by operating with compressed air injection;
running the vehicle on highway or when the storage tank is empty;
filling up the tank and permit the running of the vehicle at the same time;
regenerating the thermo-chemical heater when the latter is also empty;

Electric power energy which is used:
notably for driving the compressor during the refilling of the compressed air tank whilst the vehicle is connected to the 220 V domestic network,
for starting the unit powered by the battery,
for increasing the engine torque where necessary on an ad hoc basis,
braking the vehicle when slowing down and stopping.

The compressor-alternator unit described in the aforesaid application is also equipped with a device for controlling the piston movement characterized in that the pins of opposing pistons, and the fixed point of the pressure lever are almost aligned along the same axis, and characterized in that the pin of the control rod connected to the crankshaft is positioned not on the pin common to the hinged arms but on the arm itself between the common pin and the fixed point or pivot. For that reason the lower arm and its symmetry depict an arm at one with the pivot, or fixed point, almost in its centre and with two pins at each of its free ends connected to the opposing pistons.

The application for patent 000/4555 relates to the dialogue between the electric or electronic units of a mobile or fixed installation and more specifically of motor vehicles.

The applicant acquired the rights relating to the aforesaid application registered with INPI under the no.0701.02 125132 relating to an independent dialogue system which intends to simplify existing systems whilst controlling the systems by measuring voltages, currents, load presence, as well as faults.

The aforesaid system is characterized in that each unit comprises:

a radio transceiver

a management and independent dialogue microprocessor

a dc power supply

and communicates with the other units and more specifically with the control unit by modulated radio waves, for example by ASK, FSK or any other modulation.

This provision thus makes it possible to communicate the different switching commands to the different electric or electronic elements of an installation, at the same time as it makes it possible to take the physical measurements which it then uses to detect any operating anomaly for the element in question, and to transmit them to the other units.

Each unit in the radio receiving and/or transmitting circuit is modulated in frequency and has an individual identification code. The signal to be transmitted is constructed by a microprocessor contained in each unit; the signal is then amplified by an electronic circuit prior to its propagation by the antenna to all the other units.

The microprocessor constructs analog radio signals to be transmitted and analyzes the radio signals received and constructs a digital frame which is then decoded so as to obtain various data such as the code of the transmitting unit, the code of the receiving unit, the authorization command, the different data and parameters and the key for this frame.

The digital frame is received by all the units and the microprocessors for the aforesaid receiving units compare their individual identification code to that contained in the frame, so that the unit in question is the only one to carry out the command issued.

If the digital frame received is intended for this unit, the internal microprocessor for said unit looks to see whether it is valid. This means that the microprocessor calculates a digital key using all the bits contained in the frame received and compares it with the key contained in the frame itself. If the result gives the value zero, then the frame received does not contain a transmission error. At this stage, the microprocessor carries out the command contained in the received frame and sends a confirmation message to the transmitting unit.

For transmitting data, the unit constructs, through its internal microprocessor, a digital frame then transforms it with a carrier wave to an analog signal. The analog signal obtained in this way is amplified then propagated by the antenna to all the other units and notably to the command or control unit. Advantageously, the dialogue system radio link is set up via a conductor interconnecting all the units thus making it possible to avoid all interference.

The digital frame constructed by the microprocessor contains the code of the receiving unit, the code of the transmitting unit, the command, the data, the parameters as well as the frame key. This coding mode means that each unit knows who the transmitter is and who the receiver is.

Using this coding mode, the number of units that it is thus possible to implement simultaneously is almost without limit.

The author has also described a motor-compressor, motor-alternator unit operating with four sources of energy which can be used jointly or separately during its use notably for vehicles, according to the performances sought after or required:

Compressed air energy contained in the high pressure storage tank is the main source and is notably used to give a totally clean operation in urban areas.

Thermo-chemical energy is used to increase the performances and the autonomy of use by pollution free operating.

Fossil energy for the burner type heater which is used for:
making it possible for the unit to operate independently,
increasing performances and autonomy of use by operating with compressed air injection,
refilling the tank whilst making it possible for the unit to operate,
regenerating the thermo-chemical heater when the latter is also empty.

Electric power energy which is used:
notably for driving the compressor during the refilling of the compressed air tank whilst the vehicle is connected to the 220 V domestic network,
for starting the unit powered by the battery,
for increasing the engine torque where necessary on an ad hoc basis,

for slowing down the vehicle down when decelerating or braking.

The person skilled in the art selects the commutation mode for the various systems according to requirements and features sought after, and can program their different operating parameters, for example to bring the burner type heater into operation when the vehicle reaches a certain speed, 60 Km/h for example.

In his patent WO 02/34610 A1, the author has also described a concept of vehicle chassis. Motor vehicle chassis comprising at least a central load-bearing structure on which are fitted suspension units for the vehicle running gear and at least one floor assembly, characterized in that the central structure comprises at least two transversal structural elements usually in the form of front and rear panels, made notably of aluminium or of aluminium alloy which are connected by a series of parallel spars arranged lengthwise. Each of these spars is composed of a piece of formed section, made notably of aluminium or of aluminium alloy, of which two front and rear end segments are glued to the respective front and rear structural panels.

This invention aims to solve the problems of adapting the capacity of the passenger transport to requirements by implementing a modular vehicle operating with zero-pollution electric or compressed air engines, and more specifically with the compressed air motor-alternators/motor-compressors described above characterized in that

the vehicle comprises one or more self-propelled transport modules which are positioned one after the other and which are connected via remote control means to a driving module where the driver is located, such that the number of transport modules can be increased or reduced depending on the passenger capacity requirements.

Each driving and transport module comprises its own reserves of stored energy and compressed air, transmission motor assembly and braking means.

Each transport module comprises a steering system which is remote controlled by the steering system of the driving module which in turn is operated by the driver.

As a matter of preference, the transport modules are wire-guided and comprise an electric steering system which is controlled via an assembly of electronic devices enabling the trajectory of the driving module to be identically reproduced. In this way, the vehicle can be driven as easily as a light-duty vehicle and is extremely easy to steer in congested traffic.

A driver's cab, at the front of the driving module, comprises the video control means for each module together with all the other controls required to operate the unit correctly such as heating, opening doors and other functions.

As a matter of preference, the driving module can also be used to transport a certain number of passengers and shall operate on its own during off-peak periods, the transport modules being added as necessary to meet passenger capacity requirements.

As a matter of preference, the transport modules are connected as close as possible to the driving module and are aligned behind the latter and safety measures such as a mechanical linkage system shall be installed to prevent a transport module no longer being controlled as regards steering, accelerating, braking or other in the event of a transmission malfunction. In this event automatic means stop the entire vehicle operating.

Proximity sensors between each module are used to maintain the alignment and an even distance between each module as a matter of preference by using the motor-alternator such as described in the patent application so as to make it possible to improve and accurately maintain the distances between the modules. For this application the motor-alternator device for each engine as described in the application for patent FR 01/13798 shall be used advantageously making it possible to increase the engine torque on an ad hoc basis, or to slow the vehicle down when decelerating or braking.

The driving module and the transport modules can be completely separate or include a mechanical linkage system enabling passengers to move from one to another.

As a matter of preference, parking areas for the transport modules not in use shall be installed at the starting terminus together with compressed air filling stations so that the tanks of modules not in use can be filled during off-peak periods.

Although the transport concept according to the invention is particularly well suited to urban and suburban usage, it could be advantageously used on highways, notably using fossil fuel in a dual-energy mode such as described in the patent application.

The number of transport modules following the driving module, the remote control means, the means of operating the control module steering systems, the pneumatic or even electric motorization units, the transmissions, and the means of storing energy can vary without changing the principle of the invention which has just been described in any way.

Other objects, advantages and features of the invention will become apparent upon reading the nonlimiting description of a number of embodiments which are given with reference to the appended drawings in which:

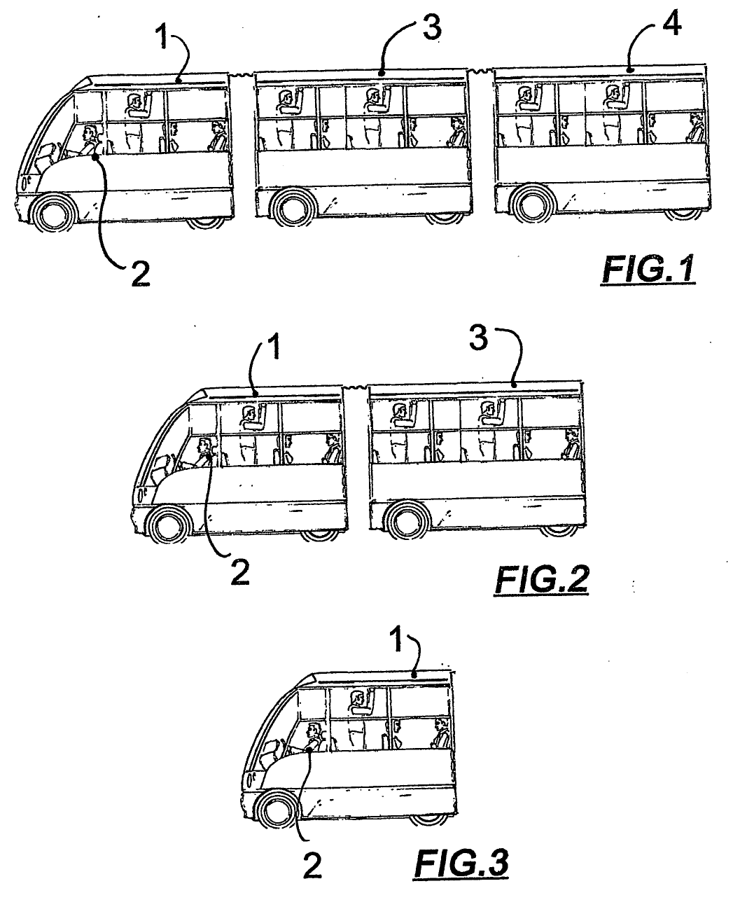

FIG. 1 is a diagrammatic depiction of a vehicle according to the invention comprising a driving module with 2 transport modules.

FIG. 2 is a diagrammatic depiction of this same vehicle with a single transport module.

FIG. 3 is a depiction of the same driving module.

In FIG. 1, the vehicle according to the invention is made up of a driving module (1) comprising a driver's cab (2) and passenger seats followed by 2 transport modules (3 and 4), to give a better understanding of these vehicle diagrams, the modules are, for example, 4 metres long, driving modules carry 25 passengers and each transport module can carry 28 passengers, making a total of 81; the modules having an operating distance of 0.5 metres, the total length of the vehicle is 13 metres which is more or less the same as that of the urban buses currently used.

In FIG. 2 a transport module has been removed and the vehicle can then carry 53 passengers and is a maximum of 8.5 metres in length.

And during off-peak periods, FIG. 3, only the driving module is used, making it possible to carry 25 passengers; consumption and size have been reduced to a third.

The advantages of the vehicle according to the invention are then clear; it not only makes it possible to use lighter modules giving an economic adequacy directly linked with the number of passengers transported but also makes it possible to circulate in congested traffic more easily.

The invention is not restricted to the embodiments described and depicted: the equipment, the means of control, the devices described can vary subject to them being equivalent, and producing the same results, without changing the invention which has just been described in any way.

1. A modular urban and suburban transport vehicle which is motorized by means of compressed air motor-alternators/motor-compressors wherein:
the vehicle comprises one or more self-propelled transport modules (2,3) which are connected via remote control means to a driving module (1) where the driver is located, such that the number of transport modules can be increased or reduced depending on the passenger capacity requirements
each driving (1) and transport (2,3) module comprises its own reserves of stored compressed air, transmission motor assembly and braking means
each transport module comprises a steering system which is remote controlled by the steering system of the driving module which in turn is operated by the driver.

2. A modular urban and suburban transport vehicle according to claim 1 characterized in that a driver's cab, at the front of the driving module (1), comprises the video control means for each module together with all the other controls required to operate the unit correctly including heating, opening doors and other functions.

3. A modular urban and suburban transport vehicle according to claim 1, wherein the remote control means for the additional transport module(s) are wire-guided.

4. A modular urban and suburban transport vehicle according to claim 1, wherein the electric steering system for the transport modules is remote controlled via an assembly of electronic devices enabling the trajectory of the driving module to be identically reproduced.

5. A modular urban and suburban transport vehicle according to claim 1, wherein the transport modules are connected as close as possible to the driving module and are aligned behind the driving module.

6. A modular urban and suburban transport vehicle according to claim 4, wherein safety measures including a mechanical linkage system are installed to prevent a transport module no longer being controlled as regards one or more of steering, accelerating and braking in the event of a transmission malfunction.

7. A modular urban and suburban transport vehicle according to claim 1 equipped with electric engines, or other motorization units, instead of compressed air motor-alternators/motor-compressors.
